(19) United States
(12) Patent Application Publication
(10) Pub. No.: US 2008/0252636 A1
(43) Pub. Date: Oct. 16, 2008

(54) Synthesis Method for Intervisibility Images

(75) Inventors: Xavier Servantie, Pessac (FR); Eric Filliatre, Merignac (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuily Sur Seine (FR)

(21) Appl. No.: 12/096,200

(22) PCT Filed: Nov. 24, 2006
(86) PCT No.: PCT/EP2006/068908

§ 371 Date: Jun. 5, 2008

(30) Foreign Application Priority Data
Dec. 7, 2005 (FR) 0512421

(51) Int. Cl. G06F 17/00

(52) U.S. Cl. 345/418

(57) ABSTRACT

The field of the invention is that of synthesis methods for a map image which is composed of pixels and represents the distribution of the intervisibility regions on a terrain overflown by an aircraft. The image synthesis method according to the invention provides both a two-dimensional cartographic representation in plan view of a terrain (T) overflown by an aircraft. The terrain has at least one potential threat (M), the intervisibility region, set of locations from where the aircraft is likely to be visible to said threat, being represented by at least one plain color. A second representation represents a view in vertical cross section of the terrain overflown. The second representation has a cross-sectional view of the intervisibility region. Various configurations of the first and of the second representations are proposed.

### CROSS-REFERENCE TO RELATED APPLICATIONS

The present Application is based on International Application No. PCT/EP2006/068908, filed on Nov. 24, 2006, which in turn corresponds to French Application No. 0512421, filed on Dec. 7, 2005, and priority is hereby claimed under 35 USC §119 based on these applications. Each of these applications are hereby incorporated by reference in their entirety into the present application.

### FIELD OF THE INVENTION

The field of the invention is that of synthesis methods for a map image which is composed of pixels and represents the distribution of the intervisibility regions on a terrain overflown by an aircraft.

Intervisibility region is taken to mean the aerial range covered by a known potential threat. Since the range of the threat has a radius, this range will be a portion of a sphere bounded in its lower part by the topography of the terrain within which the threat is located.

Depending on the topography of the terrain, there exist regions which, although situated at a shorter distance than the range radius, are not in the intervisibility region of the threat. As a result, an aircraft will or will not be within the intervisibility region of a threat depending not only on its geographical position but also on its altitude.

In view of the importance of this information for the safety of an aircraft, the representation of the intervisibility information on the display screens of the flight instrument panel of said aircraft must be as clear and as ergonomic as possible. The representation of the intervisibility regions by map image synthesis methods is therefore an important and challenging problem.

### DESCRIPTION OF THE PRIOR ART

Historically, the first graphics displays of intervisibility regions were produced by the technique referred to as the ‘radius projection’ technique. The patent U.S. Pat. No. 5,086,396 is representative of this technique. Radii are projected from the position of the threat in question up to either an obstacle limiting the effective range of the threat, or the limit of the theoretical range in the absence of obstacles. The result can be seen in FIG. 6 of said U.S. patent. The intervisibility region corresponds to the area covered by the radii. The theoretical range of the threat is indicated by a generally circular line 23A. In one preferred option, stated in claim 7, said U.S. patent proposes that a different color be assigned to each family of radii representing a different kind of threat, presumably in order to allow the pilot to distinguish between the various kinds of threat. This grid of radii projected from the threat is overlaid onto the coloring of the displayed map. This prior art presents several drawbacks. Thus, some information is lost in the parts of the map covered by the radii, such as the shading information representing the topography of the terrain. For the parts of the map which are in the intervisibility regions of several threats, possibly of different types, the reading of the information carried by the map underneath the interlacing of the radii becomes awkward or even impossible for the pilot of the aircraft. Furthermore, the aerial range is only indicated by its boundary which does not always allow the pilot to visualize it well in its entirety.

The applicant of the present application has proposed significant improvements to the ‘radius projection’ technique. In a first patent application N° 01 08669, a method has thus been proposed that is especially applicable to 2D5 cartographic representations. A 2D5 cartographic representation is a conventional two-dimensional cartographic representation in plan view in which the topography information has been displayed in the form of shading. The principle proposed is to reduce all or some of the drawbacks of the prior art by using plain colors uniformly covering the various parts of the intervisibility region in question, as opposed to the textured colors of the grid type of the prior art, partially covering the region in question, thus preventing certain pieces of information carried by the displayed map, and notably the shading information representing the topography of the terrain, from being lost. A different color is then associated with each type of region.

By way of example, FIG. 1 shows, on a terrain T, the intervisibility regions Z due to a threat M at a first altitude H of the aircraft and FIG. 2 the intervisibility regions due to the same threat M at a second altitude H+, higher than the first altitude H. On these views, the shaded areas of the topography is symbolized by hatched lines. Of course, in the case of a real display, the shaded areas are displayed in a dark color.

The distribution of the regions is as follows:
a first region Z3 represents the region which is situated within the range boundary of the threat M but outside of the intervisibility region. It has a first color represented by dots in the figures;
a second region Z2 represents the intervisibility region depending on the altitude. It has a second color represented by horizontal dashes. The extent of this region depends on the altitude of the aircraft. The higher the altitude of the aircraft, the greater the extent of the second region at the expense of the first region as can be seen by comparing FIGS. 1 and 2;
lastly, a third region Z1 represents the intervisibility region that does not depend on the altitude, in other words the region in which the aircraft is always in view. It has a third color represented by horizontal lines. It does not change in FIGS. 1 and 2.

However, this method still presents certain drawbacks. For example, when the aircraft is located in the second region Z2, situated within the range boundary of the threat but outside of the intervisibility region, the pilot is not clearly aware of the altitude margin remaining before the aircraft penetrates into the intervisibility region. In the same way, it is quite difficult for him to define the flight path to follow in order to remain continuously out of the line-of-sight, outside of or below the intervisibility region.

In the case of three-dimensional representations of the terrain, it is also possible to show the intervisibility region in the form of a semi-transparent spherical surface representing the boundaries of the intervisibility region or in the form of a portion of said surface. Thus, in a second French application N° 02 14682, the applicant has proposed an image synthesis method for aeronautics applications comprising a three-dimensional cartographic representation of a terrain overflown by an aircraft, said terrain comprising at least one potential threat, the view of the terrain being covered by a three-dimensional surface web corresponding to the lower surface of the intervisibility region. This image provides the pilot with a very ergonomic representation of the intervisibility region and facilitates the piloting of his aircraft. However, by its very principle, it only provides him with a partial view of the intervisibility region. Consequently, this principle is well adapted to flying the aircraft but is more difficult to use for navigation.

Methods for synthesizing intervisibility images are conventionally operated by using certain functional blocks of a mapping function of a card known as a cartographic accelerator using the data from a database comprising at least:
mapping data on the topography of the terrain overflown;
data relating to the localization and the range of the potential threats;
data relating to the position of the aircraft with respect to the terrain overflown.

### SUMMARY OF THE INVENTION

The object of the invention is to overcome these various drawbacks and to present the intervisibility regions to the pilot in a more ergonomic manner, allowing the pilot to be certain about, on the one hand, whether the aircraft is in an intervisibility region and, on the other hand, when the aircraft is outside of an intervisibility region, to be aware of the altitude margin remaining before the aircraft penetrates into the intervisibility region. The safety of the flight of the aircraft is thus substantially improved.

More precisely, the subject of the invention is an image synthesis method for aeronautics applications, said image composed of pixels comprising at least one two-dimensional cartographic representation in plan view of a terrain overflown by an aircraft, said terrain comprising at least one potential threat, the intervisibility region, set of locations from where the aircraft is likely to be visible to said threat, being represented by at least one plain color, characterized in that the image also comprises a second cartographic representation representing a view in vertical cross section of the terrain overflown, said cross section comprising a cross-sectional view of the intervisibility region.

Advantageously, the intervisibility region on the cross-sectional view has a plain color and the second representation also comprises a symbol representing the position of the aircraft within the cross-sectional view.

Advantageously, in the plan view, the intervisibility region comprises three complementary regions situated within the aerial range of the threat, a first region comprising the set of locations where the aircraft is continuously visible from the threat whatever its altitude, a second region comprising the set of locations where the altitude of the aircraft renders it visible from the threat and a third region comprising the set of locations where the altitude of the aircraft renders it invisible from the threat, the colors of the three regions being plain and different. The plain colors may be modulated on each pixel by shading information representative of the topography of the terrain at said pixel.

Advantageously, the cross section in the second representation is made according to a single cross-sectional plane or according to several cross-sectional planes, the flight path of the aircraft being contained within said cross-sectional planes. The second representation may also comprise a representation of the flight path of the aircraft.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 shows a cartographic representation comprising an intervisibility region at a first altitude;

FIG. 2 shows a cartographic representation comprising the same intervisibility region at a second altitude higher than the first altitude;

FIG. 3 shows an image comprising a cartographic representation obtained by a method according to the invention;

FIG. 4 shows the various cross-sectional planes of the cartographic representation according to the invention;

FIG. 5 shows one variant of the cartographic representation according to the invention.

### DETAILED DESCRIPTION OF THE INVENTION

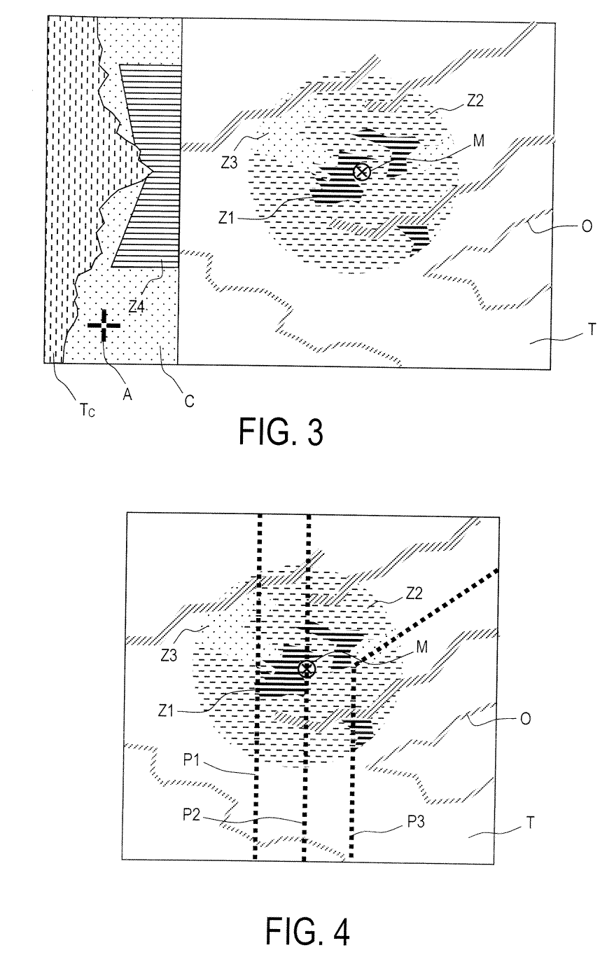

FIG. 3 shows an image comprising two cartographic representations obtained by a method according to the invention.

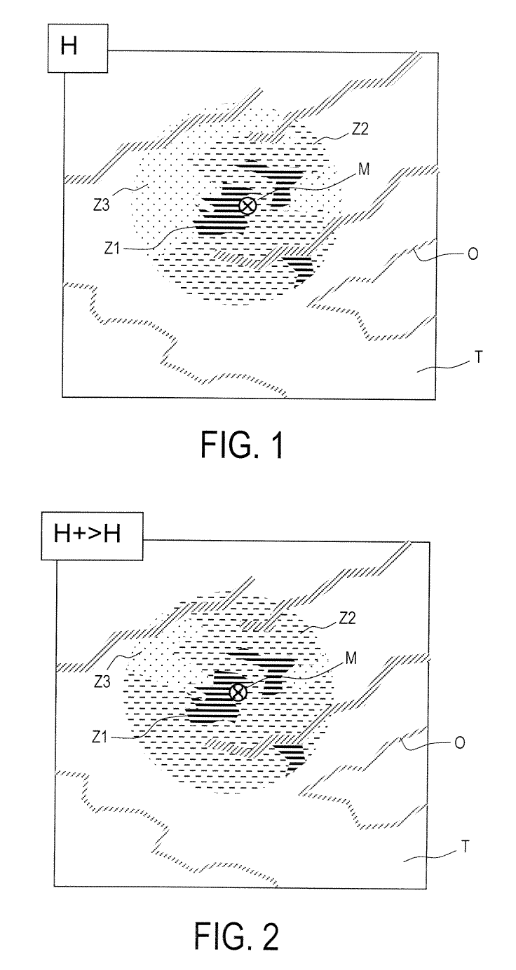

The first representation is a plan view of a terrain T overflown by an aircraft, said terrain comprising at least one geographical location where there is a potential threat M. As in FIGS. 1 and 2, the shaded areas O of the topography are symbolized by hatched lines.

The distribution of the regions is as follows:
a first region Z3 represents the region that is situated within the range boundary of the threat but outside of the intervisibility region. It has a first color represented by dots in FIG. 3;
a second region Z2 represents the intervisibility region depending on the altitude. It has a second color represented by horizontal dashes. The extent of the first and of the second region depends on the altitude of the aircraft. The higher the altitude of said aircraft, the greater the extent of the second region at the expense of the first region;
lastly, a third region Z1 represents the intervisibility region that does not depend on the altitude, in other words the region in which the aircraft is always in view. It has a third color represented by horizontal lines.

The second representation is a vertical cross-sectional view of the terrain overflown. It comprises:
a cross-sectional view T_{C} of the terrain. This cross-sectional view can be in a plain color. It may also comprise striations of different color allowing the altitude levels to be separated.
a cross-sectional view Z4 of the intervisibility region. For reasons of clarity of representation, in this view it is preferable for the intervisibility region to be in a plain color. This color can be chosen to be identical to that of the third region Z3 of the plan view.

The sky C is shown with a plain blue color on this cross section.

Thanks to this cross-sectional view, the pilot immediately determines the altitude margin allowing him to either get out of the intervisibility region or not to fly into it, information that the plan view does not allow to be determined.

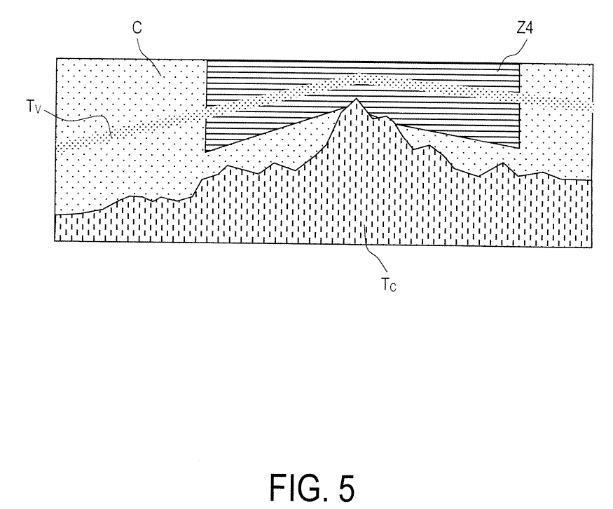

The cross-sectional view can also comprise a symbol A representing the position of the aircraft within the cross-sectional view. This cross-sectional view may be shown according to various cross-sectional planes as illustrated in FIG. 4 where the slicing of the various cross-sectional planes is shown as bold dashed lines. The cross-sectional view may be made according to a single cross-sectional plane P2 going through the threat position, or according to a single cross-sectional plane P1 situated outside of this threat. It may also be made according to several cross-sectional planes P3 within which the flight path can be contained. In this case, the cross-sectional view and the plan view may also contain a graphical representation T_{V} of the flight path as illustrated in FIG. 5 which shows a cross-sectional view in which the flight path T_{V} is represented.

In FIG. 3, the cross-sectional view is adjoined to the left-hand side of the plan view. Other arrangements are of course possible. They are essentially determined by the size of the screen on which the image is displayed and ergonomic considerations such as the ease of use of the information by the pilot depending on the disposition of the display screen in the cockpit.

The method can be used under real flight conditions in order to avoid putting the aircraft into the region of visibility from a threat. It may also be used for mission preparation simulations. The pilot thus determines on the ground the best flight path allowing him to escape from the potential threats during the real flight. This latter disposition is particularly advantageous for the preparation of low-altitude penetration missions carried out either by airplanes or by helicopters.

The synthesis method according to the invention requires means which are usually available on the avionics and helivionics systems of modern aircraft.

In flight, the complete system allowing the display of the image according to the invention comprises:
One or more Man-Machine interfaces of the control console type allowing the pilot to select the information that he needs. For example, the pilot may want a cartographic representation of the terrain and of the intervisibility region different from that linked to the real position of the aircraft.
Means for geographical localization of the aircraft in space comprising:
   Detection systems (inertial navigation system, satellite localization system of the GPS (Global Positioning system) type, etc.);
   Sensors (anemo-barometric probes, gyroscopic sensors, accelerometers, etc.)
A navigation unit for processing the data coming from the detection system and sensor chains allowing the geographical position, the altitude and the attitude of the aircraft to be determined.
A unit for generating a digital map image comprising the image of the terrain and, at least, the image of the intervisibility region according to one of the modes of presentation according to the invention. Said unit comprises:
   A mapping database comprising at least information on the topography of the terrain together with the nature and the positioning of the various potential threats.
   A processing unit allowing the image of the terrain and of the intervisibility region to be generated as a function of the data coming from the processing unit and also of the information supplied by the pilot.
   At least one display device disposed on the flight instrument panel of the MFD (Multi Function Display) type allowing the image of the terrain and of the intervisibility region to be displayed in real time.
Electronic links connecting the various units of the complete system. The transmission of the various types of information is carried out via data bus according to specific aeronautics standards.

It will be readily seen by one of ordinary skill in the art that the present invention fulfills all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. An image synthesis method for aeronautics applications, said image composed of pixels comprising at least one two-dimensional cartographic representation in plan view of a terrain (T) overflown by an aircraft, said terrain comprising at least one potential threat (M), the intervisibility region (Z1, Z2, Z3), set of locations from where the aircraft is likely to be visible and within range of said threat, being represented by at least one plain color, the image comprising a second representation representing a view in vertical cross section (T_{c}) of the terrain overflown, said second representation comprising a cross-sectional view (Z4) of the intervisibility region.

2. The synthesis method as claimed in claim 1, wherein the intervisibility region on the cross-sectional view has a plain color.

3. The synthesis method as claimed in claim 1, wherein the second representation also comprises a symbol (A) representing the position of the aircraft within the cross-sectional view.

4. The synthesis method as claimed in claim 1, wherein, in the plan view, the intervisibility region comprises three complementary regions situated within the aerial range of the threat, a first region (Z1) comprising the set of locations where the aircraft is continuously visible from the threat whatever its altitude, a second region (Z2) comprising the set of locations where the altitude of the aircraft renders it visible from the threat and a third region (Z3) comprising the set of locations where the altitude of the aircraft renders it invisible from the threat, the colors of the three regions being plain and different.

5. The synthesis method as claimed claim 1, wherein, on the plan view, the plain colors may be modulated on each pixel by shading information (O) representative of the topography of the terrain at said pixel.

6. The synthesis method as claimed in claim 1, wherein the cross section in the second representation is made according to a single cross-sectional plane (P1, P2).

7. The synthesis method as claimed in claim 1, wherein the cross section of the second representation is made according to several cross-sectional planes (P3), the flight path of the aircraft being contained within said cross-sectional planes.

8. The synthesis method as claimed in claim 1, wherein, the second representation also comprises a representation (T_{C}) of the flight path of the aircraft.

9. The synthesis method as claimed claim 4, wherein, on the plan view, the plain colors may be modulated on each pixel by shading information (O) representative of the topography of the terrain at said pixel.
